(19) United States
(12) Patent Application Publication
(10) Pub. No.: US 2017/0150492 A1
(43) Pub. Date: May 25, 2017

(54) WIRELESS COMMUNICATION SYSTEM, ACCESS POINT, AND WIRELESS DEVICE

(71) Applicant: FUJITSU LIMITED, Kawasaki-shi (JP)

(72) Inventor: Kazuyuki Ozaki, Yokohama (JP)

(73) Assignee: FUJITSU LIMITED, Kawasaki-shi (JP)

(21) Appl. No.: 15/426,783

(22) Filed: Feb. 7, 2017

Related U.S. Application Data
(63) Continuation of application No. PCT/JP2014/071431, filed on Aug. 14, 2014.

(51) Int. Cl. H04W 72/04; H04L 5/00; H04W 72/08; H04L 5/16

(52) U.S. Cl. CPC H04W 72/048; H04L 5/16; H04W 72/0446; H04L 5/0055; H04W 72/082; H04W 84/12

(57) ABSTRACT

An access point transmits, in response to a reception of a first signal transmitted from a first wireless device, a second signal addressed to a second wireless device located outside a wireless communication area of the first wireless device.

### CROSS-REFERENCE TO RELATED APPLICATION

This application is a continuation application of International Application PCT/JP2014/071431, filed on Aug. 14, 2014 and designated the U.S., the entire contents of which are incorporated herein by reference.

### FIELD

The embodiment discussed herein is related to a wireless communication system, a communication method of a wireless communication system, an access point, and a wireless device.

### BACKGROUND

In the past, in wireless communication systems such as a cellular system and a WiFi system, half-duplex communication has been the mainstream. “WiFi” is an abbreviation of “Wireless Fidelity” and is a registered trademark. In the half-duplex communication, transmission of a signal and reception of a signal are performed at different timings (for example, alternately).

On the other hand, in full-duplex communication, transmission of a signal and reception of a signal can be performed at the same timing. In other words, in the full-duplex communication, it is possible to receive (or transmit) another signal while transmitting (or receiving) a signal.

Thus, in the full-duplex communication, it is possible to improve use efficiency of time resources and the throughput of the entire system to be higher than in the half-duplex communication. For this reason, in recent years, a technique of applying a full-duplex communication function to an access point (AP) of the WiFi system and improving the throughput of the WiFi system is also under review. The “WiFi system” may also be referred to as a “wireless Local Area Network (LAN).”

### RELATED ART DOCUMENT LIST

Non-Patent Document 1: IEEE 802.11-14/0340-00-0hew

However, even when the full-duplex communication function is applied to the AP, for example, there are cases in which due to radio wave interference between wireless devices that access the AP, it is difficult to improve the throughput of the wireless communication.

### SUMMARY

In one aspect, a wireless communication system may include an access point and a plurality of wireless devices available to communicate with the access point. The access point transmits, in response to a reception of a first signal transmitted from a first wireless device, a second signal addressed to a second wireless device located outside a wireless communication area of the first wireless device.

Further, in one aspect, a wireless communication may system include an access point and a plurality of wireless devices available to communicate with the access point. A first wireless device transmits, in response to a reception of a first signal transmitted from the access point for a second wireless device located outside a wireless communication area of the first wireless device, a second signal to the access point.

Furthermore, one aspect provides a communication method of a wireless communication system which includes an access point and a plurality of wireless devices available to communicate with the access point. The communication method may include: receiving, by the access point, a first signal transmitted from a first wireless device; transmitting, by the access point, a second signal addressed to a second wireless device located outside a wireless communication area of the first wireless device in response to a reception of the first signal.

Further, in one aspect, an access point available to communicate with a plurality of wireless devices may include a receiver configured to receive a first signal transmitted from a first wireless device and a transmission controller configured to transmit a second signal addressed to a second wireless device located outside a wireless communication area of the first wireless device in response to a reception of the first signal.

Furthermore, in one aspect, a wireless device available to communicate with an access point may include a receiver configured to receive a first signal transmitted from the access point and a transmission controller configured to transmit a second signal to the access point upon detecting that a destination of the first signal is a second wireless device located outside a wireless communication area of the wireless device serving as a first wireless device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration of a WiFi system as an example of a wireless communication system according to an embodiment;

FIG. 2 is a timing chart illustrating an example of half-duplex communication;

FIG. 3 is a timing chart illustrating an example of full-duplex communication;

FIG. 4 is a diagram illustrating an example in which radio wave interference with a non-hidden terminal occurs;

FIG. 5 is a timing chart for describing an example in which radio wave interference with a non-hidden terminal occurs;

FIG. 6 is a diagram illustrating an example of communication between a wireless device and an access point in a wireless communication system illustrated in FIG. 1;

FIG. 7 is a diagram illustrating an example of an interference terminal list stored in an access point illustrated in FIGS. 1 and 6;

FIG. 8 is a flowchart for describing an exemplary operation (a first case) of an access point illustrated in FIGS. 1 and 6;

FIG. 9 is a flowchart for describing an example of a packet length adjustment process illustrated in FIG. 8;

FIG. 10 is a timing chart for describing an exemplary operation (the first case) of a wireless communication system illustrated in FIGS. 1 and 6;

FIG. 11 is a flowchart for describing an exemplary operation (a second case) of a wireless device illustrated in FIGS. 1 and 6;

FIG. 12 is a timing chart for describing an exemplary operation (the second case) of a wireless communication system illustrated in FIGS. 1 and 6;

FIG. 13 is a functional block diagram illustrating an exemplary functional configuration of an access point illustrated in FIGS. 1 and 6;

FIG. 14 is a block diagram illustrating an exemplary hardware configuration of an access point illustrated in FIGS. 1 and 6;

FIG. 15 is a functional block diagram illustrating an exemplary functional configuration of a wireless device (terminal) illustrated in FIGS. 1 and 6; and

FIG. 16 is a block diagram illustrating an exemplary hardware configuration of a wireless device (terminal) illustrated in FIGS. 1 and 6.

### DESCRIPTION OF EMBODIMENT(S)

Hereinafter, an exemplary embodiment of the present invention will be described with reference to the appended drawings. The following embodiment is merely an example and not intended to exclude the application of various modifications or techniques that are not explicitly described below. Further, various exemplary forms to be described below may be appropriately combined and carried out. In the drawings used in the following embodiment, the same reference numerals denote the same or similar parts unless otherwise set forth herein.

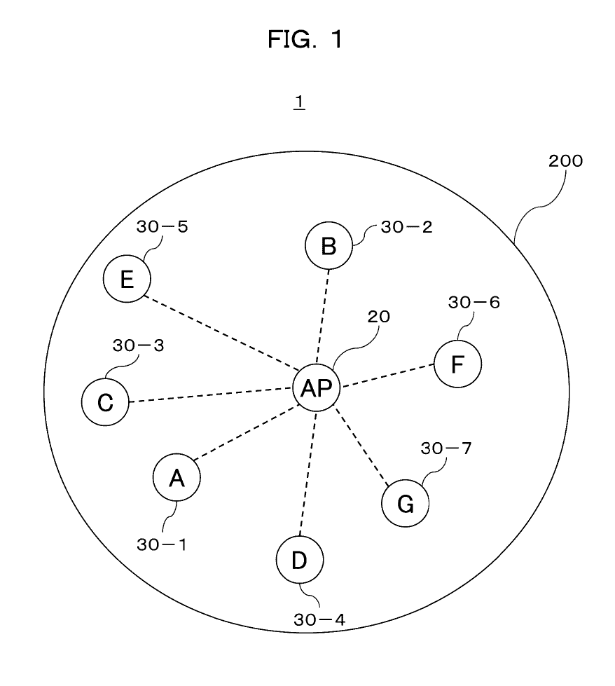

FIG. 1 is a diagram illustrating an exemplary configuration of a WiFi system as an example of a wireless communication system according to an embodiment. A WiFi system 1 illustrated in FIG. 1 includes, for example, an access point (AP) 20 and a plurality of wireless devices 30-1 to 30-N. The WiFi system 1 is also referred to as a “wireless LAN 1.”

Here, N is an integer of 2 or larger, and FIG. 1 illustrates a case of N=7, that is, a case in which the seven wireless devices 30-1 to 30-7 indicated by A to G can be connected to the AP 20. When it is unnecessary to distinguish the wireless device 30-i (i=1 to N), it is also referred to simply as a “wireless device 30.”

The AP 20 includes, for example, a full-duplex wireless communication function and can perform full-duplex communication with the wireless device 30 located in a wireless communication area 200 formed by the AP 20. A plurality of APs 20 may be installed in the wireless LAN 1. The AP 20 is also referred to as a “gateway (GW) 20.” The AP (or GW) 20 may be understood to be one of the “wireless devices.”

The wireless device 30 includes, for example, a half-duplex wireless communication function and can perform half-duplex communication with the AP 20 in the wireless communication area 200 formed by the AP 20. A name of the wireless device 30 is not particularly limited as long as it can perform the half-duplex communication with the AP 20. For example, the wireless device 30 may be referred to as a wireless device, a wireless terminal, user equipment (UE), or a node.

The wireless device 30 is a mobile object (a mobile terminal), but it is not consequential whether or not it is a device fixed to a mobile object or a fixed device whose position does not change. For example, the wireless device 30 may be a wireless terminal such as a mobile phone, a smart phone, or a tablet terminal or may be a sensor device or a meter (a measuring device) with a wireless communication function constituting a sensor network.

The wireless device 30 operates, for example, in an infrastructure mode, performs direct communication with the AP 20, but does not perform direct communication with other wireless devices 30. However, the wireless device 30 may support wireless communication with other wireless devices 30. Wireless communication between the wireless devices 30 is also referred to as “device-to-device (D2D) communication.”

For example, the same radio resources (for example, frequency resources) are used for wireless communication between the AP 20 and the wireless devices 30. In other words, the AP 20 and the wireless device 30 share the same frequency resources and perform communication with each other. Thus, the frequency resources are also referred to as “shared resources.”

In the example of FIG. 1, each of the node (may also be referred to as “terminals”) A to G is located in the wireless communication area 200 formed by the AP 20 and can transmit a signal (also referred to as “data”) directly to the AP 20 using the shared resources through one hop. The signal (or data) may include a control signal (or control data) or may include a user signal (or user data).

In the wireless communication system 1, each of the nodes 30 autonomously performs communication, for example, a Carrier Sense Multiple Access/Collision Avoidance (CSMA/CA) scheme. For example, each of the nodes 30 performs carrier sensing before data transmission and measures a reception power level of a carrier frequency.

Then, when the measured reception power level is a certain threshold value or less, each of the nodes 30 determines (also referred to as “detects”) that a channel is in an idle state, and performs the data transmission to the AP 20.

Meanwhile, when the measured reception power level is higher than a threshold value, each of the nodes 30 determines that a channel is in a busy state and does not perform the data transmission to the AP 20. “Not performing data transmission” is may be understood to be “inhibiting data transmission.”

When the channel is in the busy state, after a predetermined time elapses (or it is on standby for a predetermined time), each of the nodes 30 performs the carrier sensing again, and performs the data transmission to the AP 20 when the idle state is detected.

By the way, when all of the AP 20 and the nodes 30 are assumed to perform the half-duplex communication, the other nodes 30 are unavailable to perform communication with the AP 20 while a certain node 30 is performing communication with the AP 20.

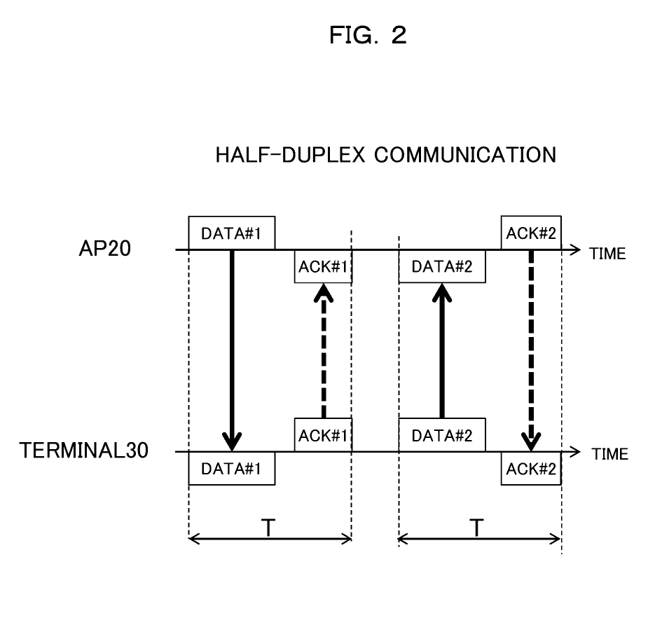

FIG. 2 illustrates an example of the half-duplex communication. FIG. 2 illustrates an example in which the AP 20 transmits a signal (for example, DATA#1) to the node 30, and the node 30 transmits a signal (for example, DATA#2) to the AP 20.

A communication link in a direction from the AP 20 to the node 30 is also referred to as a “downlink (DL),” and a communication link in an opposite direction is also referred to as an “uplink (UL).” Thus, a signal transmitted through the DL is also referred to as a “DL signal,” and a signal transmitted through the UL is also referred to as an “UL signal.”

In the half-duplex communication, for example, the AP 20 transmits the DL signal (DATA#1) addressed to the node 30, and when the DL signal is successfully received, the node 30 transmits a reception acknowledgement response signal (ACK#1) to the AP 20 as the UL signal as illustrated in FIG. 2.

In a transmission/reception time T of the DL signal (DATA#1) and the UL signal (ACK#1), the node 30 is unavailable to transmit the UL signal (for example, DATA#2) to the AP 20. After the time T elapses, the node 30 can transmit the UL signal (DATA#2) to the AP 20. When the UL signal (DATA#2) is successfully received, the AP 20 transmits a reception acknowledgement response signal (ACK#2) to the node 30 as the DL signal.

In the transmission/reception time T of the DL signal (DATA#2) and the UL signal (ACK#2), the AP 20 is unavailable to transmit the DL signal to the node 30. The transmission/reception time T of DATA#2 and ACK#2 may be different from the transmission/reception time T of DATA#1 and ACK#1.

Thus, in the example of the half-duplex communication illustrated in FIG. 2, it takes a time of a minimum of 2T until the transmission of DATA#1 from the AP 20 to the node 30 and the transmission of DATA#2 from the node 30 to the AP 20 are completed. The time T may be understood as indicating a time taken until a transmission source receives ACK and recognizes that transmission of data has been completed.

On the other hand, when the AP 20 is able to perform the full-duplex communication, transmission and reception of the DL signal and the UL signal can be performed during an overlapping period. For example, the AP 20 can transmit the DL signal to another node 30 while receiving the UL signal transmitted from a certain node 30. The AP 20 can receive the UL signal transmitted from another node 30 while transmitting the DL signal to a certain node 30.

In other words, the AP 20 may transmit the DL signal to another node 30 in response to a reception of the UL signal from a certain node 30 or may receive the UL signal from another node 30 in response to transmission of the DL signal to a certain node 30. Further, “in response to a reception” and “in response to transmission” may be interpreted to be “using reception as a trigger” and “using transmission as a trigger.”

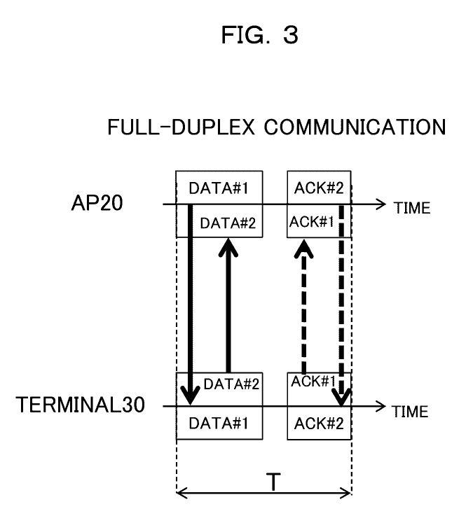

FIG. 3 illustrates an example of the full-duplex communication. The AP 20 can receive the UL signal (for example, DATA#2) from the node 30 while transmitting the DL signal (for example, DATA#1) to a certain node 30 as illustrated in FIG. 3. Further, the AP 20 can transmit ACM to the node 30 in response to DATA#2 received from the node 30 while receiving ACK#1 which is transmitted from the node 30 in response to DATA#1.

Thus, in the example of FIG. 3, compared to the example of FIG. 2, half of the time T is taken until the transmission of DATA#1 from the AP 20 to the node 30 and the transmission of DATA#2 from the node 30 to the AP 20 are completed. Thus, in the full-duplex communication, the system throughput can be improved to be twice as higher as that in the half-duplex communication.

However, when the AP 20 transmits the DL signal to a second node 30 having a positional relation in which a first node 30 may be influenced by radio wave interference while the first node 30 is transmitting the UL signal to the AP 20, the UL signal of the first node 30 may interfere with the DL signal of the AP 20.

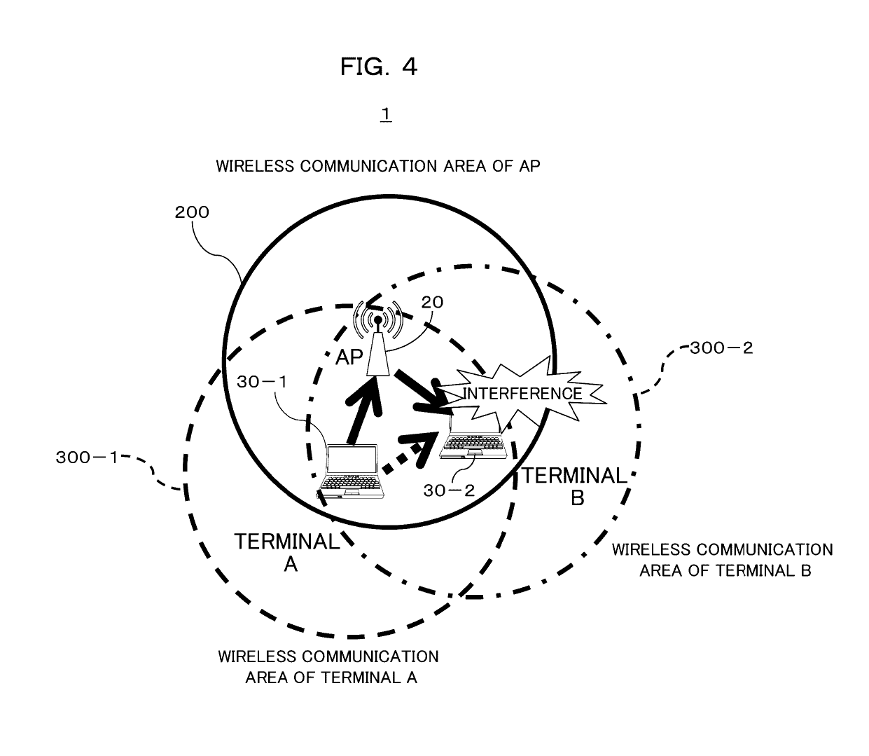

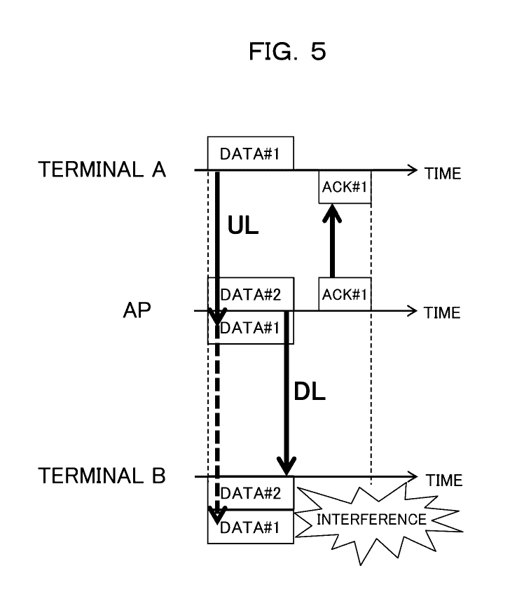

An example of the occurrence of interference is illustrated in FIGS. 4 and 5. In the example of FIG. 4, two nodes 30-1 and 30-2 (nodes A and B) are located in the wireless communication area 200 of the AP 20. The node 30-1 forms a wireless communication area 300-1, and the node 30-2 forms a wireless communication area 300-2. The “wireless communication area” is also referred to as a “coverage.”

The node 30-2 is located in the wireless communication area 300-1 of the node 30-1, and the node 30-1 is located in the wireless communication area 300-2 of the node 30-2. In other words, the three wireless devices 20, 30-1, and 30-2 are located in the overlapping area of the three wireless communication areas 200, 300-1, and 300-2.

In this positional relation, communication between the AP 20 and one node 30 may function as an interference source of communication of between the AP 20 and the other node 30. Nodes 30 having a positional relation in which it functions as an interference source of other communication are also referred to as “non-hidden terminals” or “interference terminals.”

When each of the nodes 30 is located outside the wireless communication area of the other nodes 30, such radio wave interference does not occur. Nodes 30 having a positional relation in which no radio wave interference occurs are also referred to as “hidden terminals” or “non-interference terminals.”

Here, one (for example, the node 30-1) of the node 30-1 and 30-2 having the “non-hidden terminal” relation is assumed to be transmitting the UL signal (DATA#1) to the AP 20 as illustrated in FIGS. 4 and 5.

Since the AP 20 can perform the full-duplex communication, when the AP 20 transmits the DL signal (DATA#2 to the other node 30-2 while receiving the UL signal (DATA#1) from the node 30-1, the UL signal (DATA#1) of the node 30-1 interferes with the DL signal (DATA#2) addressed to the node 30-2. For this reason, it is difficult for the node 30-2 to successfully receive the DL signal (DATA#2) from the AP 20.

Further, even when the node 30-1 serving as the “non-hidden terminal” for the node 30-2 transmits the UL signal (DATA#1) to the AP 20 while the AP 20 is transmitting, for example, the DL signal (DATA#2) addressed to the node 30-2, the UL signal interferes with the DL signal addressed to the node 30-2. For this reason, it is difficult for the node 30-2 to successfully receive the DL signal from the AP 20.

When the two wireless devices, that is, the node 30 and the AP 20 having the “non-hidden terminal” relation in which mutual radio wave interference may occur performs transmission and reception of signals at the same time, the DL signal of the AP 20 may interfere (also referred to as “collide”) with the UL signal of the node 30.

As a result, although the AP 20 performs the full-duplex communication, the system throughput is not improved, and only the system throughput that can be implemented in the half-duplex communication is likely to be obtained.

In this regard, in the present embodiment, the full-duplex communication of the AP 20 is controlled such that the two wireless devices, that is, the node 30 and the AP 20 having the “non-hidden terminal” relation in which mutual radio wave interference may occur not performs transmission and reception of signals at the same time. In other words, communication is controlled such that the full-duplex communication is allowed between the node 30 and the AP 20 having the “hidden terminal” relation in which no mutual radio wave interference occurs.

Accordingly, it is possible to inhibit or reduce the occurrence of the radio wave interference caused between the “non-hidden terminals,” and it is possible to achieve the throughput that is expected to be originally implemented in the full-duplex communication. For example, it is possible to implement the throughput that is twice as high as the throughput that can be implemented in the half-duplex communication. In other words, the performance of the wireless communication in the wireless communication system 1 can be improved.

In order to implement such communication control, for example, the AP 20 is preferably available to detect information of the nodes 30 having the “non-hidden terminal” (or “hidden terminal”) relation. In this regard, in the present embodiment, for example, each of the nodes 30 may detect other nodes (non-hidden terminals) 30 serving as interference and transmit (give a notification of) information of the detected nodes 30 to the AP 20.

For example, a second node 30 serving as interference for a certain first node 30 is a node 30 that is located at a position at which its radio wave arrives at the first node 30, and the first node 30 can receive a wireless signal.

In other words, the node 30 located in the wireless communication area of the first node 30 corresponds to the non-hidden terminal 30. For example, the first node 30 can detect and store information of the non-hidden terminal 30 by detecting information of a transmission source of a signal transmitted from another second node 30 and storing the information without discarding it.

Even the second node 30 located in the wireless communication area of the first node 30 may be determined not to correspond to the “non-hidden terminal 30” of the first node 30 (that is, to correspond to the “hidden terminal 30”).

For example, as will be described later, there are cases in which different preamble patterns are set in transmission signals for every two or more APs 20. In this case, even when the two nodes 30 that access different APs 20 are located in their own wireless communication areas, patterns of preambles of signals received from the APs 20 are different. Thus, since the nodes 30 can successfully receive a desired signal although there is mutual radio wave interference, the nodes 30 may be determined to be the “hidden terminals 30” having no mutual interference.

A notification of the information of the non-hidden terminal (the interference terminal) 30 detected by each of the nodes 30 may be given to the AP 20, for example, as information of a list form (also referred to as a “non-hidden terminal list” or a “interference terminal list”). The detection and the notification of the non-hidden terminal 30 may be performed at regular intervals or may be performed irregular intervals.

When the AP 20 transmits the DL signal while receiving the UL signal from a certain node 30, the AP 20 selects the hidden terminal 30 that does not function as the interference source for the transmission source node 30 of the UL signal based on the interference terminal list received from each of the nodes 30, and transmits the DL signal to the hidden terminal 30.

In other words, the AP 20 exclude the non-hidden terminal 30 that interferes with the UL signal being received from a transmission destination candidate of the DL signal by transmitting the DL signal based on the interference terminal list. In other words, the AP 20 selects the transmission destination of the DL signal while avoiding the non-hidden terminal 30 that interferes with the UL signal being received based on the interference terminal list. The “selecting” is also referred to as “scheduling.”

On the other hand, when the node 30 transmits the UL signal addressed to the AP 20, the node 30 determines whether or not the transmission destination node 30 of the DL signal being transmitted from the AP 20 is included in the interference terminal list held in its own node 30. When the transmission destination node 30 of the DL signal of the AP 20 is not included in the interference terminal list, since no interference occurs even when the UL signal is transmitted, the node 30 transmits the UL signal addressed to the AP 20. On the other hand, when the transmission destination node 30 of the DL signal of the AP 20 is included in the interference terminal list, since interference occurs when the UL signal is transmitted, the node 30 inhibit the transmission of the UL signal addressed to the AP 20.

In other words, the node 30 excludes a time in which the AP 20 transmits the DL signal to another node 30 included in the interference terminal list from a transmission timing candidate of the UL signal addressed to the AP 20. In other words, the node 30 controls the transmission timing of the UL signal addressed to the AP 20 such that a time in which the AP 20 is transmitting the DL signal to another node 30 included in the interference terminal list is avoided.

(Exemplary Operation)

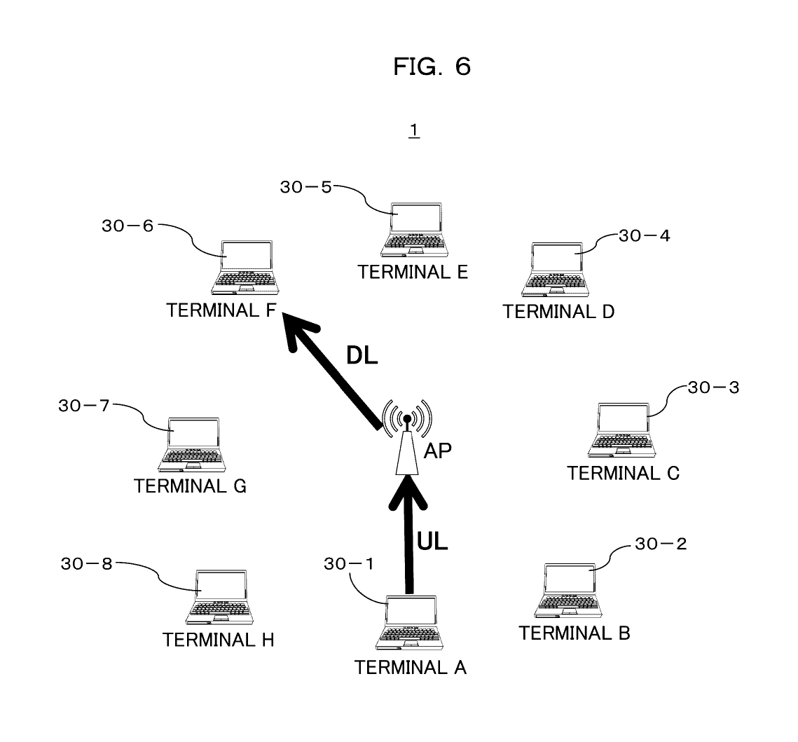

An example of the above-described communication control will be described below with reference to FIGS. 6 to 11. A case in which eight node 30-1 to 30-8 (terminals A to H) are located in the wireless communication area 200 of the AP 20, and the terminal A transmits the UL signal to the AP 20 is assumed as illustrated in FIG. 6.

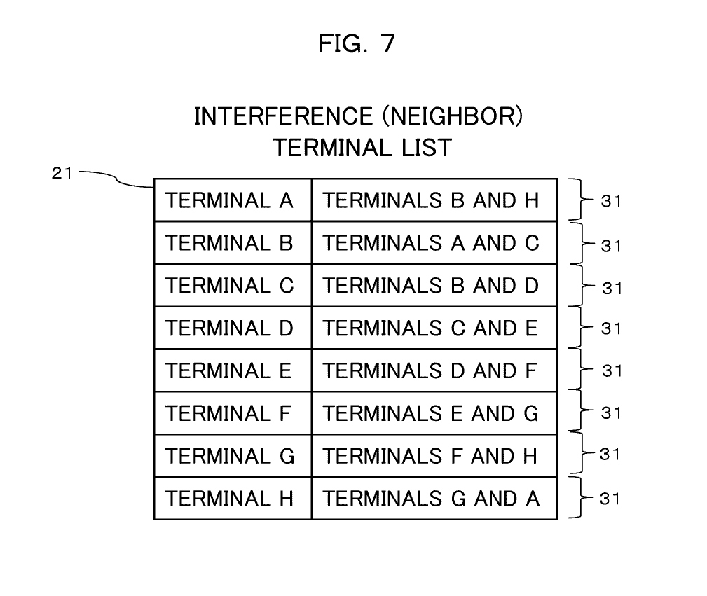

The AP 20 stores, for example, an interference terminal list 21 illustrated in FIG. 7. A first entry of the interference terminal list 21 indicates that the terminals B and H indicated in a second column are the interference terminals for the terminal A indicated in a first column. The same applies to subsequent entries, and the interference terminal for each of the terminals B to H indicated in the first column of the interference terminal list 21 is registered in the second column. A to H may be understood to be identification information of the terminals A to H. The “interference terminal” is also referred to as a “neighbor terminal” in terms of a positional relation.

The information registered in the entries of the interference terminal list 21 illustrated in FIG. 7 is reported from the terminals A to G at regular intervals or at irregular intervals as described above. Thus, each of the terminals A to G may be understood to store information corresponding to the individual entries of the interference terminal list 21 illustrated in FIG. 7 as an interference terminal list 31.

Here, a first case in which the AP 20 transmits the DL signal while receiving the UL signal from the terminal A and a second case in which the terminal A transmits the UL signal to the AP 20 while the AP 20 is transmitting the DL signal to the terminal 30 other than the terminal A will be described.

(First Case)

In the first case, for example, it is assumed that the terminal A transmits the UL signal to the AP 20, and the AP 20 transmits the DL signal to the non-interference terminal (also referred to as a “non-neighbor terminal”) 30 of the terminal A in response to a reception of the UL signal.

As illustrated in FIG. 7, the interference terminals for the terminal A are the terminals B and H, and the terminals C to G excluding the interference terminals B and H are the non-interference terminals for the terminal A. The AP 20 receives the UL signal from the terminal A, performs preamble detection of the UL signal, and decodes a header field.

The “preamble” is an example of a signal having a pattern known between the AP 20 and the terminals A to G and used for establishing synchronization of transmission and reception signals. As the synchronization is established, for example, the AP 20 can identify a reception timing of the header field and decode the header field at an appropriate timing.

When there are a plurality of APs 20, the preamble (pattern) differs according to (a BSSID of) the AP 20. The BSSID is an abbreviation of “Basic Service Set Identifier.” The BSSID is an example of identification information identifying the AP 20 and may be, for example, a MAC address of the AP 20.

For example, information identifying a transmission source, a data length, a modulation scheme, a transmission speed, or the like of a signal having a header field added thereto may be set in the header field. The information identifying the transmission source of the signal is also referred to as “transmission source information” and may be address information such as a MAC address. The AP 20 can identify the transmission source, the data length, the modulation scheme, the transmission speed, or the like of the received UL signal based on the decoded information of the header field.

Thereafter, the AP 20 selects (estimates) the non-interference terminal 30 (for example, the terminal F) for the identified terminal A based on the interference terminal list 21 constructed based on the interference terminal list 31 reported from the terminals A to H at regular intervals or irregular intervals, and checks whether or not the DL signal addressed to the terminal F is held in a transmission buffer of the AP 20.

When the DL signal addressed to the terminal F is held in the transmission buffer, the AP 20 transmits the DL signal addressed to the terminal F. At this time, the DL signal addressed to the terminal F may come around from the transmission antenna of the AP 20 and be received by the reception antenna as an interference signal. However, since the AP 20 knows that its own AP 20 is transmitting the DL signal, the AP 20 can cancel the DL signal component from the signal received through the reception antenna. Thus, the AP 20 can successfully receive the UL signal transmitted from the terminal A to the AP 20.

Here, since the transmission destination terminal F of the DL signal and the transmission source terminal A of the UL signal have the non-interference terminal relation, the UL signal transmitted from the terminal A to the AP 20 does not interfere with the DL signal transmitted from the AP 20 to the terminal F. Thus, the DL signal transmitted from the AP 20 to the terminal F is also successfully received by the terminal F.

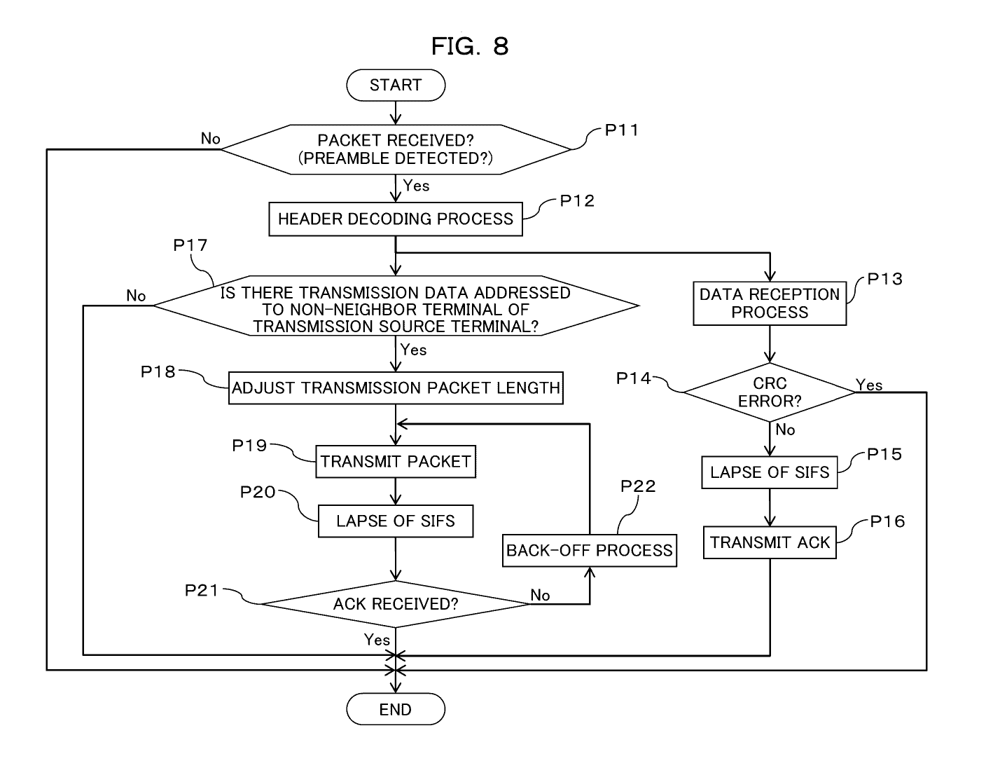

FIG. 8 is a flowchart illustrating an exemplary operation of the AP 20 in the first case. FIG. 8 illustrates an example in which the DL signal and the UL signal are packet data (hereinafter, also referred to as a “packet”).

As illustrated in FIG. 8, the AP 20 determines whether or not a packet is received by determining whether or not a preamble is detected (process P11). When a preamble fails to be detected, the AP 20 determines that a packet is not received and need not perform a subsequent reception process (No in process P11).

Meanwhile, when a preamble is detected (Yes in process P11), the AP 20 decodes the header field (process P12), and performs a reception process of a data field (process P13). Based on the transmission source address information included in a decoded result of the header field, the AP 20 can identify the transmission source terminal 30 (for example, the terminal A) of the received packet.

The packet reception process may include demodulation of the data field and error correction decoding using a cyclic redundancy check (CRC) code. When the received packet has no CRC error (No in process P14), the AP 20 is on standby until a lapse of a short inter frame space (SIFS) time (process P15) and then transmits an ACK signal to the transmission source terminal A of the received packet (process P16). When there is a CRC error (Yes in process P14), the AP 20 may discard the received packet having the CRC error and end the packet reception process.

The AP 20 checks whether or not the packet addressed to the non-interference terminal 30 for the transmission source terminal 30 (for example, the terminal A) identified based on the decoded result of the header field is held in the buffer in response to the reception of the packet (the detection of the preamble) (process P17). The checking may be performed based on, for example, the interference terminal list 21 illustrated in FIG. 7.

When the packet addressed to the non-interference terminal 30 (for example, the terminal F) is not held in the buffer (No in process P17), the AP 20 does not perform DL transmission. On the other hand, when the packet addressed to the non-interference terminal F is held in the buffer (Yes in process P17), the AP 20 adjusts a length of the packet addressed to the non-interference terminal F based on a packet length identified from the decoded result of the header field (process P18).

For example, the AP 20 calculates (also referred to as “estimates) a timing (also referred to as a “reception end timing”) at which the reception of the UL packet from the terminal A is expected to end (be completed) based on the identified packet length.

Then, the AP 20 adjusts the packet length of the DL packet addressed to the terminal F so that transmission of the DL packet addressed to the non-interference terminal F for the terminal A ends at the calculated reception end timing, and transmits the packet to the terminal F (process P19). The adjustment of the DL packet length is an example of an adjustment of a DL signal length. A transmission period of the DL signal addressed to the terminal 30 can be easily controlled by adjusting the DL packet length.

Thereafter, the AP 20 is on standby, for example, until the lapse of the SIFS time (process P20) and then monitors whether or not the ACK signal is received from the terminal F (process P21).

When the ACK signal is received (Yes in process P21), the AP 20 may identify that the transmission of the DL packet addressed to the terminal F is normally completed and end the process. When the ACK signal is not received even after a predetermined time elapses (No in process P21), the AP 20 may perform a back-off process such as retransmission control on the terminal F (process P22). For example, the AP 20 may retransmit the packet to the terminal F until the ACK signal is received from the terminal F.

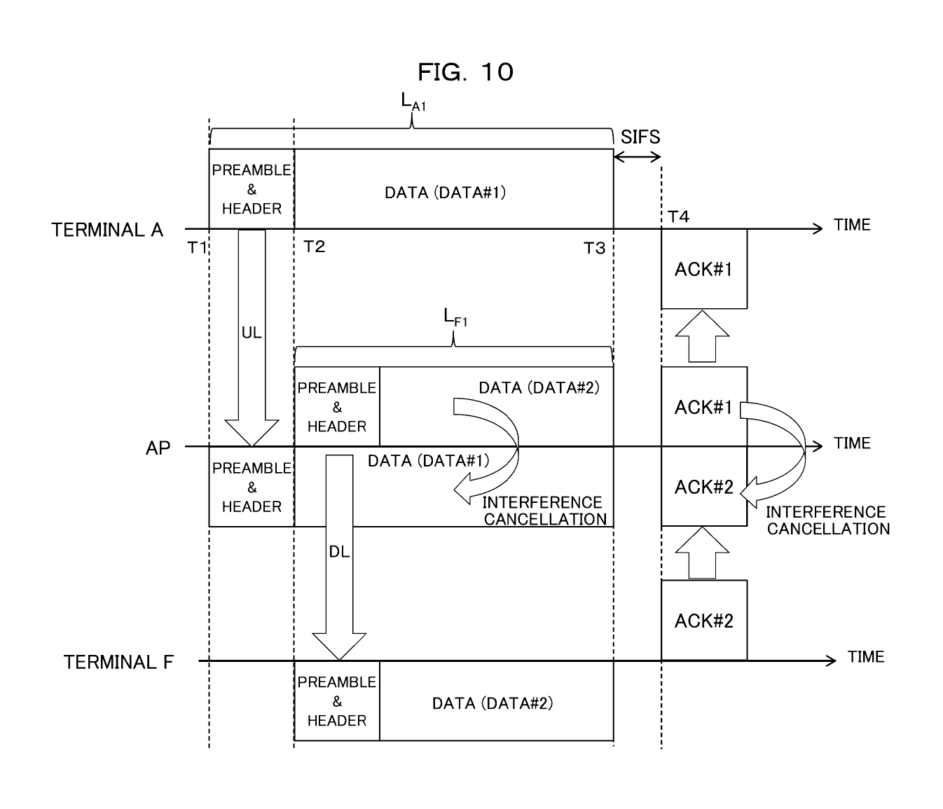

Next, FIG. 10 is a timing chart schematically illustrating an example of the transmission packet length adjustment process in the first case. In FIG. 10, the terminal A and the terminal F have the “hidden terminal” relation and correspond to the non-neighbor terminal for each other.

The terminal A starts transmission of the UL packet to the AP 20 at a timing T1. The packet length of the UL packet is, for example, L_{A1} (L_{A1} is a positive real number). Thus, the terminal A ends (completes) the transmission of the UL packet at a timing T3 (T3>T1) which is after a time taken for transmission of the packet length L_{A1} from the timing T1.

The AP 20 detects the preamble of the UL packet transmitted from the terminal A, and decodes the header field (hereinafter, also referred to simply as a “header”) when the preamble detection is successfully performed. Based on the decoded result, the AP 20 identifies that the transmission source of the received UL packet is the terminal A.

The AP 20 checks whether or not the transmission data addressed to the non-interference terminal F not serving as the interference for the identified transmission source terminal A is held in the transmission buffer. When the transmission data addressed to the terminal F is held in the transmission buffer, the AP 20 calculates a DL packet size (for example, a packet length Lₙ) that can be transmitted to the non-interference terminal F for the terminal A based on the packet length (L_{A1}) set in the decoded header.

For example, a timing at which the non-interference terminal F for the terminal A is assumed to be identified based on the interference terminal list 21 (see FIG. 7) by identifying the transmission source terminal A of the UL packet, and the AP 20 enters a state in which the DL packet can be transmitted to the terminal F is assumed to be T2 (T1<T2<T3).

In this case, the AP 20 calculates the packet length L_{F1} of the DL packet that can be transmitted between the timing T2 and the timing T3 corresponding to the reception end timing of the UL packet. Then, the AP 20 reads transmission data of a data amount corresponding to the packet length L_{F1} which is addressed to the terminal F from the transmission buffer, generates the DL packet of the packet length L_{F1} addressed to the terminal F, and transmits the DL packet of the packet length L_{F1} to the terminal F. Accordingly, a transmission end timing of the DL packet addressed to the terminal F is identical to the reception end timing (the timing T3) of the UL packet from the terminal A.

The AP 20 can successfully receive the UL packet from the terminal A by cancelling the DL signal transmitted through its own transmission antenna from the signal received through the reception antenna.

After the reception of the UL packet and the transmission of the DL packet are completed at the timing T3, it is standby until the lapse of the SIFS time, and then, for example, at a timing T4, the AP 20 transmits the ACK signal to the terminal A, and the terminal F transmits the ACK signal to the AP 20.

Since the reception of the UL packet and the transmission of the DL packet are completed at the same timing T3, the transmission and reception timings of the ACK signals for the UL packet and the DL packet are also identical.

For example, the transmission timing of the ACK signal addressed to the terminal A and the reception timing of the ACK signal transmitted from the terminal F in the AP 20 are identical. Thus, a situation in which when the packet length of the DL packet is not adjusted, for example, in the AP 20, transmission of the DL packet addressed to the terminal F overlaps transmission of the ACK signal addressed to the terminal A, and thus it is difficult to transmit the two signals can be prevented. In other words, it is possible to reduce a waste of time resources and improve the throughput.

The AP 20 can successfully receive the ACK signal transmitted from the terminal F to the AP 20 by cancelling the ACK signal transmitted through the transmission antenna from the AP 20 to the terminal A from the signal received through the reception antenna.

(Specific Example of Transmission Packet Length Adjustment Process)

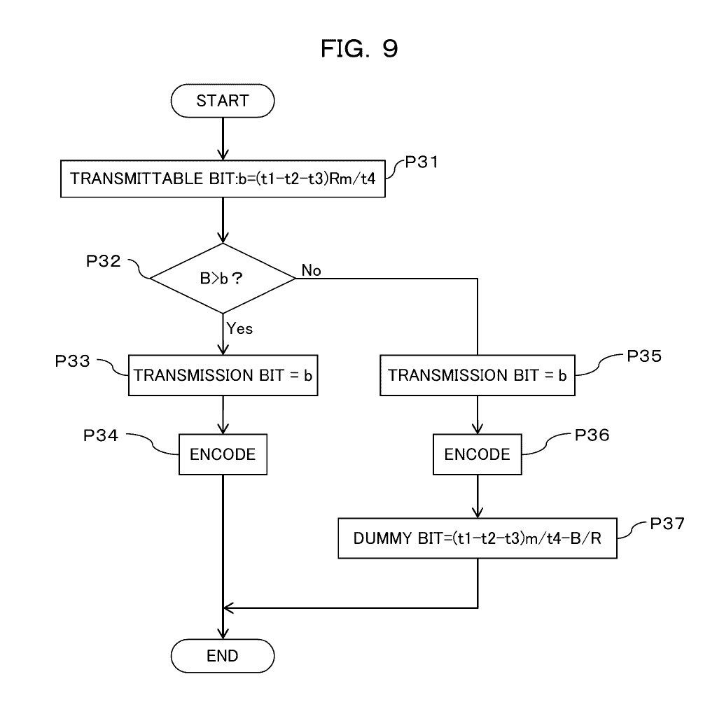

Next, a specific example of the transmission packet length adjustment process (P18) illustrated in FIG. 8 will be described with reference to FIG. 9.

The AP 20 can obtain the timing (the reception end timing) t1 at which the reception of the received packet is completed based on the packet length included in the decoded result of the header of the received packet. A timing t1 corresponds to, for example, the timing T3 illustrated in FIG. 10.

Here, a current timing is indicated by “t2,” a time corresponding to a total length of the preamble and the header is indicated by “t3,” a time corresponding a 1 symbol length is “t4,” the number of transmission bits of a transmission packet per symbol is indicated by “m,” and a code rate is indicated by “R.” In this case, the AP 20 can calculate the number b of transmittable data bits using the following Formula 1 (process P31).

### [Mathematical Formula 1]

$$b = \frac{mR ( t 1 - t 2 - t 3 )}{t 4}$$

The AP 20 compares the number b of transmittable data bits calculated by Formula (1) with the number B of data bits held in the transmission buffer at the current timing t2 (process P32).

When the number B of data bits of the transmission buffer is larger than the number b of transmittable data bits as a result of comparison (Yes in process P32), the AP 20 decides the number of transmission data bits to be b (process P33).

Then, the AP 20 reads the transmission data corresponding to the decided number b of bits from the transmission buffer and encodes the transmission data at the code rate R (process P34). Accordingly, the transmission packet having the packet length matching the reception end timing of the received packet can be generated as illustrated in FIG. 10.

On the other hand, when the number B of data bits of the transmission buffer is the number b of transmittable data bits or less (No in process P32), the AP 20 decides the number of transmission data bits to be B (process P35), and encodes the transmission data corresponding to the number B of bits at the code rate R (process P36).

When the number B of data bits of the transmission buffer is larger than the number b of transmittable data bits, the AP 20 inserts the number D of bits calculated by the following Formula 2 into the transmission packet as dummy bits.

### [Mathematical Formula 2]

$$D = \frac{m ( t 1 - t 2 - t 3 )}{t 4} - \frac{B}{R}$$

Through the insertion of the dummy bits, the transmission packet having the packet length matching the reception end timing of the received packet can be generated as illustrated in FIG. 10.

(Second Case)

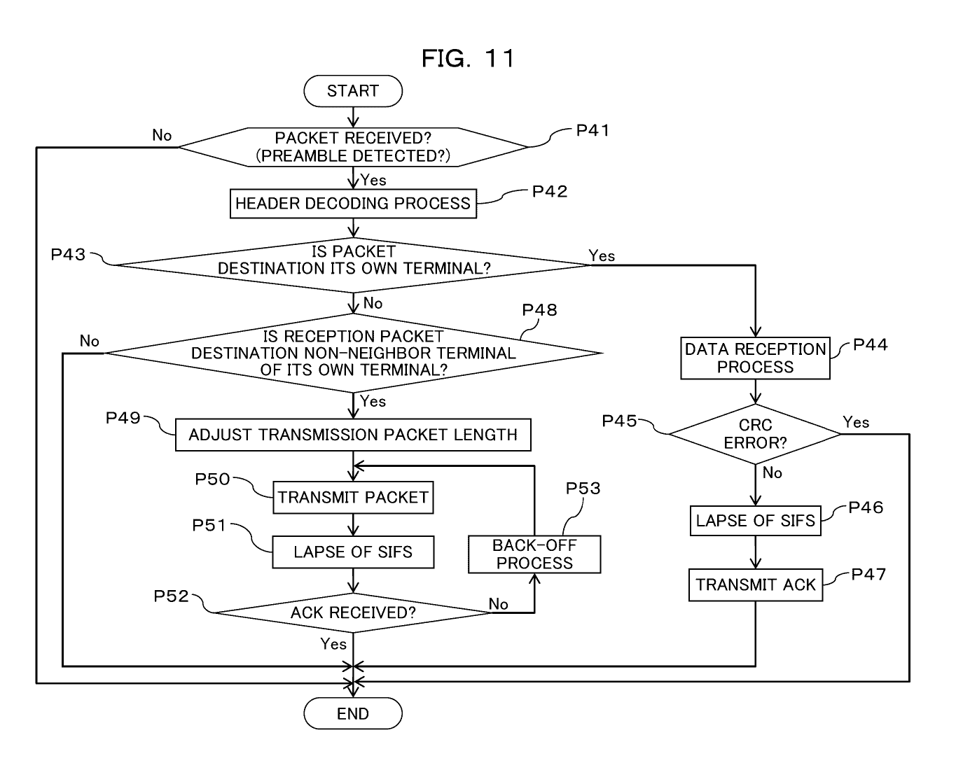

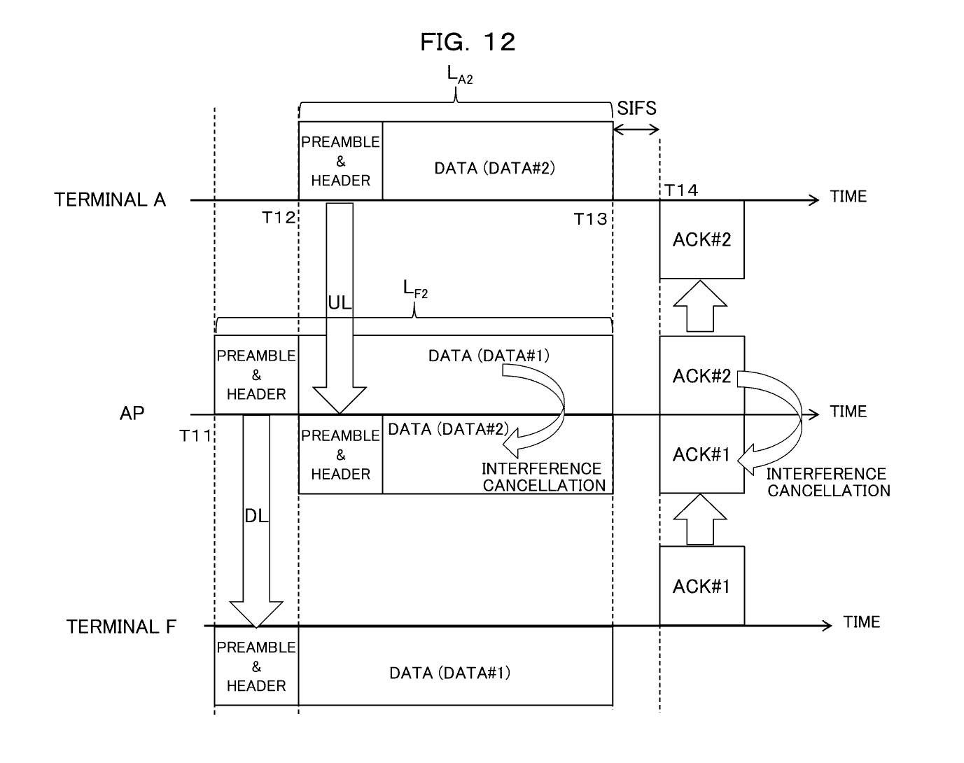

Next, the second case in which the terminal A transmits the UL signal to the AP 20 while the AP 20 is transmitting the DL signal to a certain terminal 30 other than the terminal A, for example, in FIG. 6 will be described with reference to FIGS. 11 and 12.

FIG. 11 is a flowchart illustrating an exemplary operation of the terminal A in the second case, and FIG. 12 is a timing chart illustrating an example of transmission and reception timings of the packet in the second case. FIGS. 11 and 12 illustrate an example in which the DL signal and the UL signal are packets.

As illustrated in FIG. 11, the terminal 30 (for example, the terminal A) determines whether or not a packet is received by determining whether or not a preamble is detected (process P41). When a preamble fails to be detected, the terminal A determines that a packet is not received and need not perform a subsequent reception process (No in process P41).

Meanwhile, when a preamble is detected (Yes in process P41), the terminal A decodes the header field (process P42), and determines whether or not the destination of the received packet identified from the destination information of the decoded result is its own terminal A (process P43).

When the received packet is determined to be its own terminal A (Yes in process P43), the terminal A performs the reception process of the data field of the packet (process P44). The packet reception process may include demodulation of the data field and error correction decoding using a CRC code.

When the received packet has no CRC error (No in process P45), the terminal A is on standby until a lapse of the SIFS time (process P46) and then transmits the ACK signal to the AP 20 (process P47). When there is a CRC error (Yes in process P45), the terminal A may discard the received packet having the CRC error and end the packet reception process.

On the other hand, when the received packet is not addressed to its own terminal A (No in process P43), the terminal A determines whether or not the destination of the received packet is the neighbor terminal (for example, the interference terminal F) of its own terminal A which is registered in the interference terminal list 31 (see FIG. 7) (process P48).

When the destination of the received packet is determined to be the interference terminal (for example, the terminal B or the terminal H in FIG. 6) for its own terminal A (No in process P48), if the terminal A transmits the UL packet to the AP 20, the UL packet may interfere (collide) with the DL packet addressed to the interference terminal. For this reason, the terminal A ends the transmission and inhibits the transmission of the UL packet.

On the other hand, when the received packet is addressed to the non-interference terminal (for example, the terminal F) for its own terminal A (Yes in process P48), the terminal A identifies the packet length of the packet based on the decoded result of the header of the packet addressed to the terminal F.

Then, the terminal A calculates the reception end timing of the packet addressed to the terminal F, that is, the transmission end timing of the packet addressed to the terminal F by the terminal A, based on the identified packet length. The terminal A adjusts the packet length of the UL packet so that the transmission of the UL packet from the terminal A to the AP 20 ends at the calculated end timing (process P49), and transmits the UL packet to the AP 20 (process P50). The packet length adjustment process is similar to one described in processes P31 to P37 illustrated in FIG. 9. The adjustment of the UL packet length is an example of an adjustment of an UL signal length. A transmission period of the UL signal addressed to the AP 20 can be easily controlled by adjusting the UL packet length.

After the transmission of the UL packet ends, the terminal A is on standby until the lapse of the SIFS time (process P51) and then monitors whether or not the ACK signal for the UL packet is received from the AP 20 (process P52).

When the ACK signal is received (Yes in process P52), the terminal A may identify that the transmission of the UL packet is successfully completed and end the process. When the ACK signal is not received even after a predetermined time elapses (No in process P52), the terminal A may perform the back-off process such as retransmission control on the AP 20 (process P53). For example, the terminal A may retransmit the packet to the AP 20 until the ACK signal is received from the AP 20.

Next, FIG. 12 is a timing chart schematically illustrating an example of the transmission packet length adjustment process in the second case. In FIG. 12, the terminal A and the terminal F have the “hidden terminal” relation and correspond to the non-neighbor terminal for each other.

The AP 20 starts transmission of the DL packet to the terminal F at a timing T11. The packet length of the DL packet is, for example, L_{F2} (L_{F2} is a positive real number). Thus, the AP 20 ends (completes) the transmission of the DL packet at a timing T13 (T13>T11) which is after a time taken for transmission of the packet length L_{F2} from the timing T1.

Meanwhile, when the DL packet addressed to the terminal F is received through the preamble detection, the terminal A determines that the received packet is the DL packet addressed to the non-interference terminal F for its own terminal A based on the decoded result of the header.

Then, the terminal A calculates the end timing T13 of the DL packet addressed to the terminal F based on the packet length L_{F2} set in the decoded header, and calculates a packet size (for example, the packet length L_{A2}) that can be transmitted to the AP 20 until the end timing T13.

For example, a timing at which the terminal A generates the transmission data addressed to the AP 20 and enters a state in which the UL packet addressed to the AP 20 can be transmitted is assumed to be T12 (T11<T12<T13).

In this case, the terminal A calculates the packet length L_{A2} of the UL packet that can be transmitted between the timing T12 and the timing T13 corresponding to the end timing of the DL packet addressed to the terminal F. Then, the terminal A reads transmission data of a data amount corresponding to the packet length L_{A2} which is addressed to the AP 20 from the transmission buffer, generates the UL packet of the packet length L_{A2} addressed to the AP 20, and transmits the UL packet of the packet length L_{A2} to the AP 20. Accordingly, the transmission end timing of the UL packet addressed to the AP 20 is identical to the end timing (the timing T13) of the DL packet addressed to the terminal F.

The AP 20 can successfully receive the UL packet from the terminal A by cancelling the DL signal addressed to the terminal F transmitted through its own transmission antenna from the signal received through the reception antenna.

After the transmission of the DL packet and the reception of the UL packet are completed at the timing T13, it is standby until the lapse of the SIFS time, and then, for example, at a timing T14, the terminal F transmits the ACK signal to the AP 20, and the AP 20 transmits the ACK signal to the terminal A.

Since the transmission of the DL packet and the reception of the UL packet are completed at the same timing T13, the transmission and reception timings of the ACK signals for the DL packet and the UL packet are also identical.

For example, the reception timing of the ACK signal transmitted from the terminal F and the transmission timing of the ACK signal addressed to the terminal A in the AP 20 are identical. Thus, a situation in which when the terminal A does not adjust the packet length of the UL packet, for example, in the AP 20, transmission of the DL packet addressed to the terminal F overlaps transmission of the ACK signal addressed to the terminal A, and thus it is difficult to transmit the two signals can be prevented. In other words, it is possible to reduce a waste of time resources and improve the throughput.

The AP 20 can successfully receive the ACK signal transmitted from the terminal F to the AP 20 by cancelling the ACK signal transmitted through the transmission antenna from the AP 20 to the terminal A from the signal received through the reception antenna.

As described above, according to the embodiment including the first and second cases, the terminal 30 reports the information of other interference terminals 30 that may have mutual radio wave interference to the AP 20, and the AP 20 selects the terminal 30 having no mutual radio wave interference based on the reported information and performs the full-duplex communication.

In other words, in the full-duplex communication by the AP 20, it is possible to optimize selection of the terminal 30 that performs transmission and reception in the same period.

For example, the AP 20 can selects the non-interference terminal 30 for the terminal 30 as the destination and transmit the DL signal while receiving the UL signal from a certain terminal 30.

Further, the terminal 30 can select a time in which the destination of the DL signal transmitted from the AP 20 is the non-interference terminal 30 for its own terminal 30 and transmit the UL signal to the AP 20. In other words, in the wireless communication system 1, the non-interference terminal 30 that does not interfere with the destination terminal 30 of the DL signal transmitted from the AP 20 is selected as the terminal 30 capable of transmitting the UL signal.

In this way, the throughput of the wireless communication system 1 can be improved.

For example, in the wireless communication system 1, a UL communication time is indicated by “T_{UL},” an UL bit rate is indicated by “B_{UL},” a DL communication time is indicated by “T_{DL},” and a DL bit rate is indicated by “B_{DL},” the DL throughput of the half-duplex communication is T_{DL}B_{DL}/T_{DL}=B_{DL}. The UL throughput of the half-duplex communication is T_{UL}B_{UL}/T_{UL}=B_{UL}.

On the other hand, according to the full-duplex communication by the AP 20, since signals can be transmitted and received in the time resources of both the UL communication time T_{UL} and the DL communication time T_{DL}, the DL throughput is (T_{DL}+T_{UL})B_{DL}/T_{DL}=(1+T_{UL}/T_{DL})B_{DL}. The UL throughput is (T_{DL}+T_{UL})B_{UL} T_{UL}=(1+T_{DL} T_{UL})B_{UL}.

Thus, compared to the half-duplex communication, the DL throughput can be increased to be a multiple of 1+T_{UL}/T_{DL}, and the UL throughput can be increased to be a multiple of 1+T_{DL}/T_{UL}. When the UL communication time T_{UL} and the DL communication time T_{DL} are identical to each other, each of the DL and UL throughputs becomes twice.

(Exemplary Configuration of AP 20 and Terminal 30)

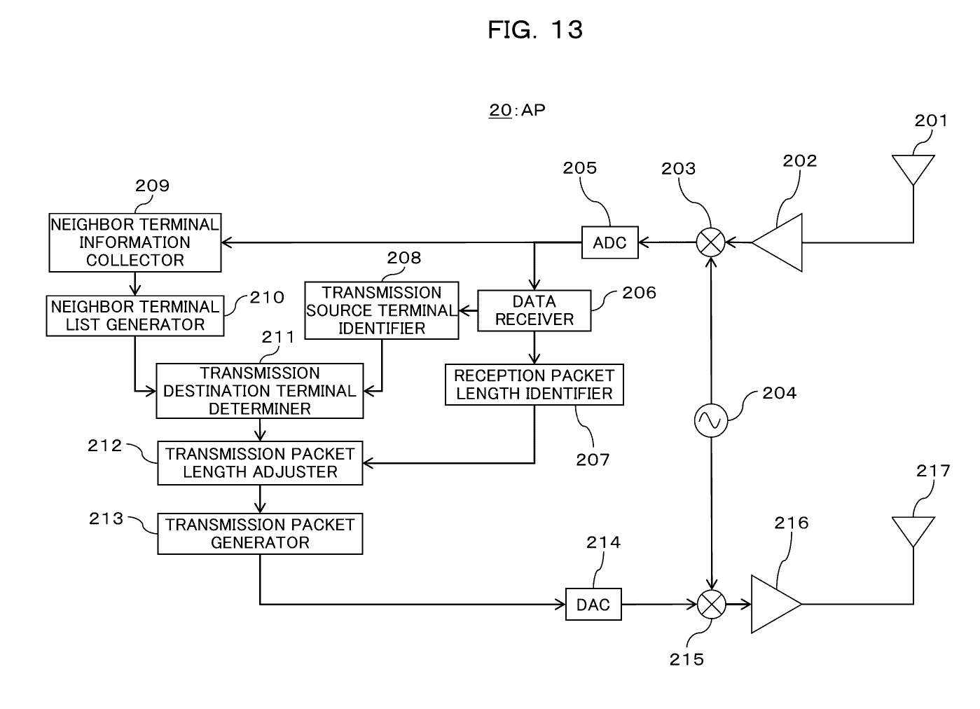

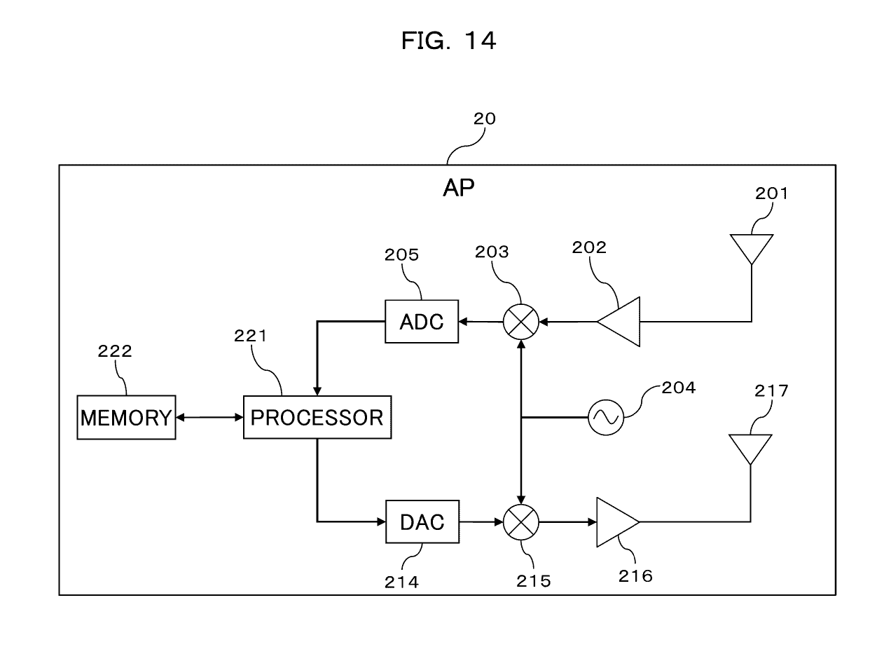

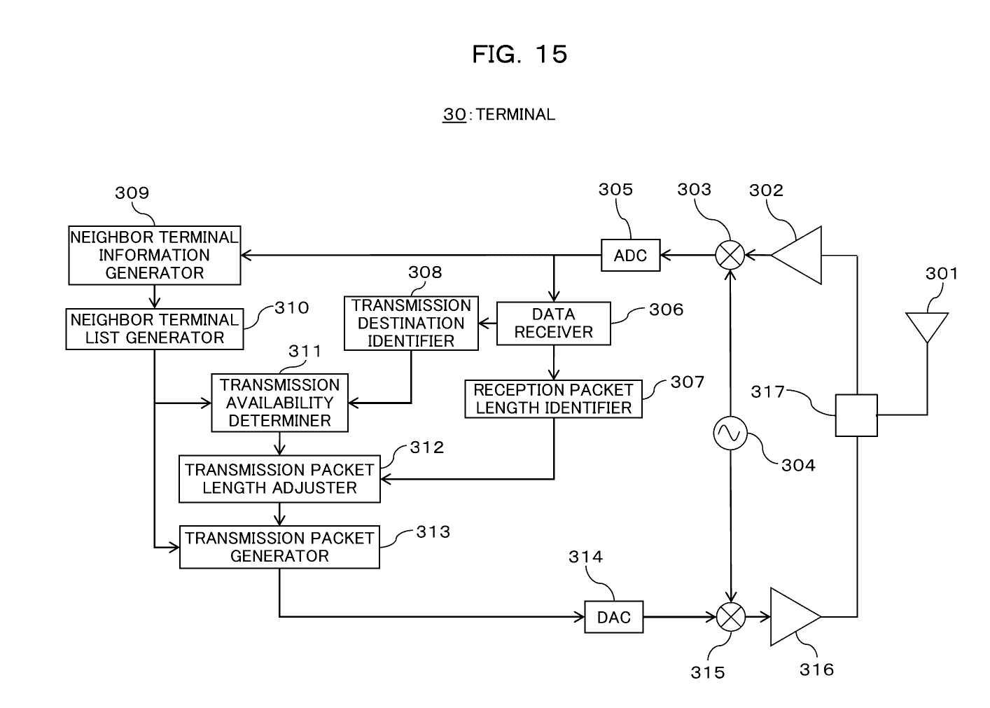

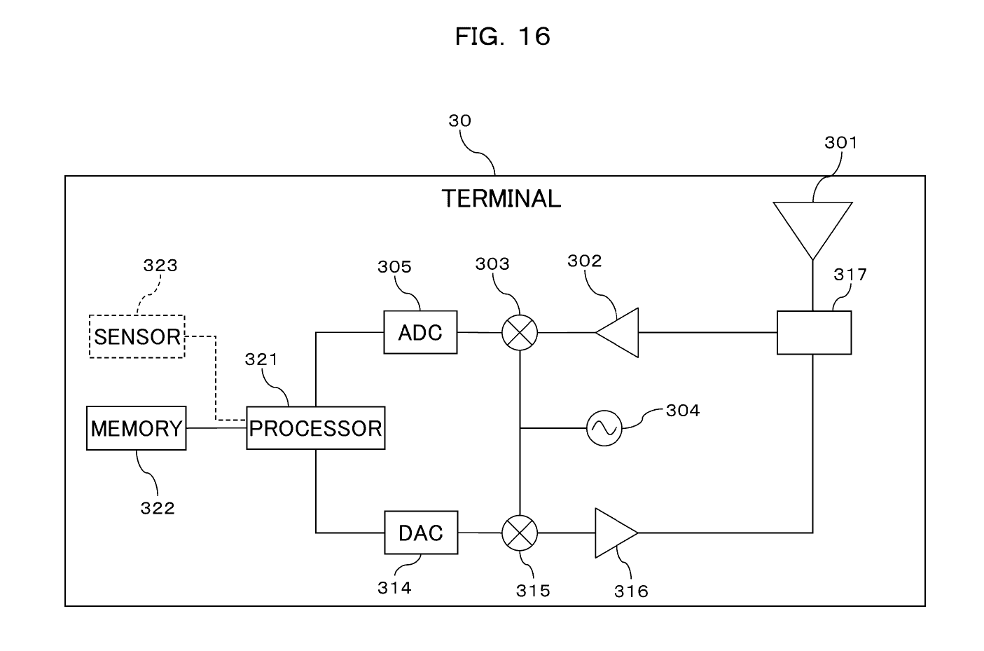

Next, exemplary configurations of the AP 20 and terminal 30 will be described with reference to FIGS. 13 to 16. FIG. 13 is a functional block diagram illustrating an exemplary functional configuration of the AP 20, and FIG. 14 is a functional block diagram illustrating an exemplary functional configuration of the terminal 30. FIG. 15 is a block diagram illustrating an exemplary hardware configuration of the AP 20, and FIG. 16 is a block diagram illustrating an exemplary hardware configuration of the terminal 30.

(Exemplary Functional Configuration of AP 20)

The AP 20 illustrated in FIG. 13 includes, for example, a reception antenna 201, a reception amplifier 202, a reception mixer (multiplier) 203, a local oscillator 204, an analog-digital converter (ADC) 205, a data receiver 206, and a reception packet length identifier 207.

The AP 20 includes, for example, a transmission source terminal identifier 208, a neighbor terminal information collector 209, a neighbor terminal list generator 210, a transmission destination terminal determiner 211, a transmission packet length adjuster 212, and a transmission packet generator 213. The AP 20 further includes, for example, a digital-analog converter (DAC) 214, a transmission mixer (multiplier) 215, a transmission amplifier 216, and a transmission antenna 217.

The reception antenna 201 receives a signal radiated into space as a radio wave.

The reception amplifier 202 amplifies the signal received through the reception antenna 201. The reception amplifier 202 may be, for example, a low noise amplifier (LNA).

The reception mixer 203 performs frequency conversion (also referred to as “down conversion”) from a reception signal of a radio frequency (RF) into a baseband signal by mixing (multiplying) the reception signal amplified through the reception amplifier 202 with (by) an output signal of the local oscillator 204.

The local oscillator 204 oscillates an alternating current (AC) signal of a continuous wave used for the down conversion and frequency conversion (also referred to as “up conversion”) by the transmission mixer 215, and outputs a resulting signal.

The ADC 205 converts the analog reception signal that is down-converted into the baseband signal through the reception mixer 203 into a digital signal.

The data receiver 206 performs, for example, the preamble detection on the digital reception signal obtained by the ADC 205 and decodes the header.

The reception packet length identifier 207 identifies the packet length of the packet serving as the digital reception signal based on the decoded result of the header obtained by the data receiver 206. A notification of the identified packet length is given to, for example, the transmission packet length adjuster 212.

The transmission source terminal identifier 208 identifies the transmission source terminal 30 of the received packet based on the decoded result of the header obtained by the data receiver 206. A notification of information of the identified transmission source terminal 30 is given to, for example, the transmission destination terminal determiner 211.

The neighbor terminal information collector 209 collects the interference terminal list 31 that is detected and transmitted by each terminals 30, for example, from based on the digital reception signal obtained by the ADC 205, and transmits the interference terminal list 31 to the neighbor terminal list generator 210.

The neighbor terminal list generator 210 generates the interference terminal list 21 illustrated in FIG. 7 based on the interference terminal list 31 received from the neighbor terminal information collector 209. The generated interference terminal list 21 is transferred to, for example, the transmission destination terminal determiner 211.

The data receiver 206, the reception packet length identifier 207, the transmission source terminal identifier 208, the neighbor terminal information collector 209, and the neighbor terminal list generator 210 may be understood to correspond to an example of a receiver (or a reception system) that receives the UL signal transmitted from the terminal 30. The reception antenna 201, reception amplifier, the reception mixer 203, and the ADC 205 may be included in the receiver.

The transmission destination terminal determiner 211 selects and determines the non-interference terminal 30 in which the DL signal transmitted in response to a reception of the UL signal does not interfere with the UL signal in the first case based on the interference terminal list 21.

The transmission packet length adjuster 212 adjusts the packet length of the DL packet to be transmitted to the non-interference terminal 30 as described above with reference to FIGS. 8 to 10. For example, the transmission packet length adjuster 212 calculates the reception end timing of the packet based on the UL reception packet length identified by the reception packet length identifier 207.

Then, the transmission packet length adjuster 212 adjusts the packet length (that is, a transmission data amount) of the DL packet addressed to the non-interference terminal 30 so that the transmission of the DL packet addressed to the non-interference terminal 30 determined by the transmission destination terminal determiner 211 ends at the calculated reception end timing.

The transmission packet generator 213 generates a transmission (DL) packet in which the transmission data of the data amount adjusted by the transmission packet length adjuster 212 is included in the data field. Further, the transmission packet generator 213 adds a header field including address information indicating the transmission source and destination to the data field.

The transmission destination terminal determiner 211, the transmission packet length adjuster 212, and the transmission packet generator 213 may be understood to correspond to an example of a transmitter (or a transmission system) that transmits a DL packet (data) addressed to the terminal 30.

The transmitter may be understood to correspond to an example of a transmission controller that transmits a DL signal serving as an example of a second signal addressed to a second terminal 30 located in outside a wireless communication area of a first terminal 30 in response to a reception of a UL signal serving as an example of the first signal transmitted from the first terminal 30. The DAC 214, the transmission mixer 215, the transmission amplifier 216, and the transmission antenna 217 may be included in the transmitter.

The DAC 214 converts the DL packet serving as a digital transmission signal generated by the transmission packet generator 213 into an analog signal.

The transmission mixer 215 performs up conversion from the DL analog transmission signal into a wireless signal by mixing the output signal of the DAC 214 with the output signal of the local oscillator 204.

The transmission amplifier 216 amplifies the DL transmission signal that is up-converted into the wireless signal through the transmission mixer 215 to have specified transmission power. The transmission amplifier 216 may be, for example, a high power amplifier (HPA). The transmission power of the transmission amplifier 216 may be variably controlled.

The transmission antenna 217 radiates the DL transmission signal amplified by the transmission amplifier 216 into space as a radio wave.

(Exemplary Hardware Configuration of AP 20)

Next, an exemplary hardware configuration of the AP 20 will be described with reference to FIG. 14. A configuration of the AP 20 illustrated in FIG. 14 differs from the configuration illustrated in FIG. 13 in that a processor 221 and a memory 222 are provided.

The processor 221 is an example of an operation device with an operation function such as a central processing unit (CPU) or a digital signal processor (DSP) and controls an overall operation of the AP 20. The operation device is also referred to as a “processor device” or a “processor circuit.”

The processor 221 reads a program or data stored in the memory 222 and operates, and thus the functions of the respective units 206 to 213 illustrated in FIG. 13 are implemented.

The memory 222 is an example of a storage device that stores the program or data and may be a random access memory (RAM), a hard disk drive (HDD), or the like. The interference terminal list 21 illustrated in FIG. 7 is stored in the memory 222. The memory 222 is equipped with the transmission buffer described above. When an amount of transmission data held in the transmission buffer is smaller than an amount of transmittable data, the packet length adjustment based on the dummy bits with reference to FIG. 9 is performed.

(Exemplary Functional Configuration of Terminal 30)

Next, an exemplary functional configuration of the terminal 30 will be described with reference to FIG. 15. The terminal 30 illustrated in FIG. 15 includes, for example, a transceiving antenna 301, an antenna duplexer 317, a reception amplifier 302, a reception mixer (multiplier) 303, a local oscillator 304, an ADC 305, a data receiver 306, and a reception packet length identifier 307.

The terminal 30 further includes, for example, a transmission destination identifier 308, a neighbor terminal information generator 309, a neighbor terminal list generator 310, a transmission availability determiner 311, a transmission packet length adjuster 312, and a transmission packet generator 313. The terminal 30 further includes, for example, a DAC 314, a transmission mixer (multiplier) 315, and a transmission amplifier 316.

The transceiving antenna 301 radiates the UL transmission signal output from the transmission amplifier 316 into space as a radio wave, and receives the DL signal radiated into space as a radio wave.

The antenna duplexer 317 outputs the DL signal received through the transceiving antenna 301 to the reception amplifier 302, and outputs the UL signal output from the transmission amplifier 316 to the transceiving antenna 301.

The reception amplifier 302 amplifies the reception signal that is received through the transceiving antenna 301 and input from the antenna duplexer 317. The reception amplifier 302 may be, for example, an LNA.

The reception mixer 303 performs frequency conversion (down conversion) from the reception signal of the radio frequency (RF) into the baseband signal by mixing (multiplying) the reception signal amplified through the reception amplifier 302 with (by) an output signal of the local oscillator 304.

The local oscillator 304 oscillates an AC signal of a continuous wave used for the down conversion and frequency conversion (up conversion) by the transmission mixer 315, and outputs a resulting signal.

The ADC 305 converts the analog reception signal that is down-converted into the baseband signal through the reception mixer 303 into a digital signal.

The data receiver 306 performs, for example, the preamble detection on the digital reception signal obtained by the ADC 305 and decodes the header.

The reception packet length identifier 307 identifies the packet length of the packet serving as the digital reception signal based on the decoded result of the header obtained by the data receiver 306. A notification of the identified packet length is given to, for example, the transmission packet length adjuster 312.

The transmission destination identifier 308 identifies the destination terminal 30 of the received packet based on the decoded result of the header obtained by the data receiver 306. A notification of information of the identified destination terminal 30 is given to, for example, the transmission availability determiner 311.

The neighbor terminal information generator 309 detects the neighbor terminal (the interference terminal) 30 having the “non-hidden terminal” relation with its own terminal 30, for example, based on the digital reception signal obtained by the ADC 305, and generates information of the detected neighbor terminal 30.

The neighbor terminal list generator 310 generates the interference terminal list 31 (see FIG. 7) based on the information of the neighbor terminal generated by the neighbor terminal information generator 309. The generated interference terminal list 31 is transferred to, for example, the transmission availability determiner 311 and the transmission packet generator 313.

The data receiver 306, the reception packet length identifier 307, the transmission destination identifier 308, the neighbor terminal information generator 309, and the neighbor terminal list generator 310 may be understood to correspond to an example of a receiver (or a reception system) that receives the DL signal transmitted from the AP 20. The transceiving antenna 301, the reception amplifier 302, the reception mixer 303, and the ADC 305 may be included in the receiver.

The transmission availability determiner 311 determines whether or not the destination terminal 30 of the DL reception signal identified by the transmission destination identifier 308 is registered in the interference terminal list 31 as the interference terminal 30 based on the interference terminal list 31 in the second case.

Then, the transmission availability determiner 311 determines the UL signal addressed to the AP 20 to be transmitted when the destination terminal 30 of the DL reception signal is the interference terminal 30, and inhibit transmission of the UL signal to the AP when the destination terminal 30 of the DL reception signal is the interference terminal 30.

The transmission packet length adjuster 312 adjusts the packet length of the UL packet to be transmitted to the AP 20 as described above with reference to FIGS. 11, 12, and 9. For example, the transmission packet length adjuster 312 calculates the reception end timing of the packet based on the DL reception packet length identified by the reception packet length identifier 307.

Then, the transmission packet length adjuster 312 adjusts the packet length (that is, a transmission data amount) of the UL packet addressed to the AP 20 so that the transmission of the UL packet addressed to the AP 20 ends at the calculated reception end timing.

The transmission packet generator 313 generates a transmission (UL) packet in which the transmission data of the data amount adjusted by the transmission packet length adjuster 312 is included in the data field. Further, the transmission packet generator 313 adds a header field including address information indicating the transmission source and destination to the data field.

The transmission availability determiner 311, the transmission packet length adjuster 312, and the transmission packet generator 313 may be understood to correspond to an example of a transmitter (or a transmission system) that transmits a UL packet (data) to the AP 20. The transmitter may be understood to correspond to an example of a transmission controller that transmits a UL signal serving as an example of a second signal addressed to an AP 20 upon detecting that a destination of a DL signal serving as an example of a first signal is a second terminal 30 located outside a wireless communication area of its own terminal 30 serving as the first terminal. The DAC 314, the transmission mixer 315, the transmission amplifier 316, and the transceiving antenna 301 may be included in the transmitter.

The DAC 314 converts the UL packet serving as a digital transmission signal generated by the transmission packet generator 313 into an analog signal.

The transmission mixer 315 performs up conversion from the UL analog transmission signal into a wireless signal by mixing the output signal of the DAC 314 with the output signal of the local oscillator 304.

The transmission amplifier 316 amplifies the UL transmission signal that is up-converted into the wireless signal through the transmission mixer 315 to have specified transmission power. The transmission amplifier 316 may be, for example, a HPA. The transmission power of the transmission amplifier 316 may be variably controlled.

The UL transmission signal amplified through the transmission amplifier 316 is output to the transceiving antenna 301 via the antenna duplexer 317, and a radio wave is radiated from the transceiving antenna 301 into space.

(Exemplary Hardware Configuration of Terminal 30)

Next, an exemplary hardware configuration of the terminal 30 will be described with reference to FIG. 16. A configuration of the terminal 30 illustrated in FIG. 16 differs from the configuration illustrated in FIG. 15 in that a processor 321 and a memory 322 are provided.

The processor 321 is an example of an operation device with an operation function such as a CPU or a DSP and controls an overall operation of the terminal 30.

The processor 321 reads a program or data stored in the memory 322 and operates, and thus the functions of the respective units 306 to 313 illustrated in FIG. 15 are implemented.

The memory 322 is an example of a storage device that stores the program or data and may be a RAM, a HDD, or the like. The interference terminal list 31 (see FIG. 7) is stored in the memory 322. The memory 322 is equipped with the transmission buffer described above. When an amount of transmission data held in the transmission buffer is smaller than an amount of transmittable data, the packet length adjustment based on the dummy bits with reference to FIG. 9 is performed.

In FIG. 16, as indicated by a dotted line, the terminal 30 may be equipped with a sensor 323. The sensor 323 senses (measures) a physical amount of one or more of temperature, humidity, pressure, a position, displacement, distance, a speed, acceleration, an angular speed, a voltage, an electric current, magnetism, light, or the like.

A measurement result of the sensor 323 may be transferred to, for example, the processor 321 and transmitted through the transceiving antenna 301. In other words, the terminal 30 equipped with the sensor 323 may be understood to correspond to a sensor device or a meter (a measuring device) with a wireless communication function. The sensor may be installed in the AP 20. In other words, the AP 20 may correspond to a sensor device or a meter (a measuring device) with a wireless communication function.

According to the above-described technology, as one aspect, the performance of the wireless communication can be improved.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment (s) of the present invention have been described in detail, it should be understood that the various changes, substitutions, and alterations could be made hereto without departing from the spirit and scope of the invention.

What is claimed is:

1. A wireless communication system comprising:
an access point; and
a plurality of wireless devices available to communicate with the access point,
wherein the access point transmits, in response to a reception of a first signal transmitted from a first wireless device, a second signal addressed to a second wireless device located outside a wireless communication area of the first wireless device.

2. The wireless communication system according to claim 1,
wherein the access point controls a transmission period of the second signal such that transmission of the second signal ends at a reception end timing of the first signal.

3. The wireless communication system according to claim 1,
wherein each of the plurality of wireless devices transmits information of another wireless device located in a wireless communication area of the wireless device to the access point, and
the access point determines the second wireless device located outside the wireless communication area of the first wireless device based on the information of the wireless device.

4. An access point available to communicate with a plurality of wireless devices, the access point comprising:
a receiver configured to receive a first signal transmitted from a first wireless device; and
a transmission controller configured to transmit a second signal addressed to a second wireless device located outside a wireless communication area of the first wireless device in response to a reception of the first signal.

5. The access point according to claim 4,
wherein the transmission controller controls a transmission period of the second signal such that transmission of the second signal ends at a reception end timing of the first signal.

6. The access point according to claim 5,
wherein the control of the transmission period includes adjustment of a signal length of the second signal.

7. The access point according to claim 5,
wherein the transmission controller transmits an acknowledgement response signal for the first signal to the first wireless device after an end timing of a reception of the first signal, and
the receiver receives an acknowledgement response signal for the second signal from the second wireless device during transmission of the acknowledgement response signal for the first signal.

8. The access point according to claim 4,
wherein the receiver receives information of another wireless device located in each of wireless communication areas of the plurality of wireless devices from the plurality of wireless devices, and
the transmission controller determines the second wireless device located outside the wireless communication area of the first wireless device based on the received information of the wireless device.

9. A wireless device available to communicate with an access point, comprising:
a receiver configured to receive a first signal transmitted from the access point; and
a transmission controller configured to transmit a second signal to the access point upon detecting that a destination of the first signal is a second wireless device located outside a wireless communication area of the wireless device serving as a first wireless device.

10. The wireless device according to claim 9,
wherein the transmission controller controls a transmission period of the second signal such that transmission of the second signal ends at a reception end timing of the first signal.

11. The wireless device according to claim 10,
wherein the control of the transmission period includes an adjustment of a signal length of the second signal.

12. The wireless device according to claim 10,
wherein the receiver receives an acknowledgement response signal for the second signal transmitted from the access point during a period in which the access point receives an acknowledgement response signal for the first signal from the second wireless device after an end timing of transmission of the second signal.

13. The wireless device according to claim 9,
wherein the receiver detects information of another wireless device located in the wireless communication area of the first wireless device, and
the transmission controller detects that the second wireless device is not located in the wireless communication area of the first wireless device based on the information of the wireless device.
